(19) United States
(12) Patent Application Publication
(10) Pub. No.: US 2007/0107559 A1
(43) Pub. Date: May 17, 2007

(54) Ratchet breakover tool

(76) Inventors: Bradley M. Bryson, Columbus, TX (US); Barry D. Rutta, Columbus, TX (US)

Correspondence Address: Law Office of David McEwing PC, PO Box 231324, Houston, TX, 77223, US

(21) Appl. No.: 11/273,933

(22) Filed: Nov. 15, 2005

(51) Int. Cl. B25B 13/46; B25B 23/16; B25G 1/04

(52) U.S. Cl. 81/60; 81/177.2; 81/177.8

(57) ABSTRACT

A tool comprising a handle having a first end and a second end and further comprising a ratchet tool at the first handle end and a breakover tool at the second handle end. Also a ratchet breakover tool comprising a tool handle approximately 5 inches to 21 inches in length having a first end and a second end, a reversible ratchet tool attached to the first handle end and comprising a socket pin with a diameter of ¼ inch to ¾ inch and a socket wrench detent; and a breakover tool attached to the second handle end and comprising a socket pin pivotally attached to the breakover tool head and with a diameter of ¼ inch to ¾ inch and a socket wrench detent.

### BACKGROUND OF THE INVENTION

1. Field of Use

The invention relates to hand powered tools used with socket wrenches for the installation or removal of threaded nuts or bolts or similar work pieces.

2. Related Art

Related tools include conventional ratchet wrenches and similar hand tools. Also air powered ratchet drills are tools related to the present invention.

### SUMMARY OF INVENTION

A tool comprising a handle having a first end and a second end and further comprising a ratchet tool at the first handle end and a breakover tool at the second handle end. Also a ratchet breakover tool comprising a tool handle approximately 5 inches to 21 inches in length having a first end and a second end, a reversible ratchet tool attached to the first handle end and comprising a socket pin with a diameter of ¼ inch to ¾ inch and a socket wrench detent; and a breakover tool attached to the second handle end and comprising a socket pin pivotally attached to the breakover tool head and with a diameter of ¼ inch to ¾ inch and a socket wrench detent.

### SUMMARY OF DRAWINGS

The accompanying drawings, which are incorporated in and constitute a part of the specification, illustrate embodiments of the invention. These drawings, together with the general description of the invention given above and the detailed description of the invention given below, serve to explain the principles of the invention.

FIG. 1 illustrates a top view of a conventional ratchet head of a reversible ratchet tool, including a ratchet wheel with ratchet teeth, pawl and controller (pawl lever) and a sprocket pin.

FIG. 2 illustrates a side view of the reversible ratchet tool head depicted in FIG. 1.

FIG. 3 illustrates a side view of an improved reversible ratchet head subject of U.S. Pat. No. 5,761,972.

FIG. 4 illustrates a top view of the tool head subject of FIG. 3 with a cover removed and a portion of the handle broken away.

FIG. 5 illustrates another top view of a tool head subject of FIG. 3 and FIG. 4.

FIG. 6 illustrates a top view of one embodiment of the tool subject of the present invention showing the ratchet tool head and socket pin and the breakover tool head with a pivotally attached socket pin.

FIG. 7 illustrates a side view of the tool subject of the invention and showing the variable positions of the socket pin of the breakover tool head in relation to the longitudinal axis of orientation of the tool handle.

FIG. 8 illustrates a top view of another embodiment of a tool subject of the invention having a ratchet tool head and a breakover tool head wherein the socket pin is in a set position on the breakover tool head and relative to the tool handle.

FIG. 9 illustrates a side view of the tool depicted in FIG. 8, including the oblique angle of orientation of the socket pin to the longitudinal axis of the tool handle.

FIG. 10 illustrates a side view of an embodiment of the invention wherein the socket pin of the breakover component is positioned normal or 90 degrees to the longitudinal axis of the tool handle.

FIG. 11 illustrates a side view of an embodiment of the invention wherein the ratchet tool head and the breakover tool head are pivotally attached to the tool handle.

FIG. 12 is a top view of the invention illustrated in FIG. 11.

FIGS. 13 and 14 illustrate another embodiment of the tool subject of the invention wherein a socket pin is set in the opposite end of a tool handle from a reversible ratchet tool.

### DETAILED DESCRIPTION OF THE INVENTION

The above general description and the following detailed description are merely illustrative of the subject invention and additional modes, advantages and particulars of this invention will be readily suggested to those skilled in the art without departing from the spirit and scope of the invention.

Ratchet tools of various configurations are known. As illustrated and described herein, ratchet tools are comprised of numerous components. The multiple components are subject to wear and breakdown. Wear and breakdown is aggravated by excessive torque force being applied by the user via the handle in attempting to loosen stuck or frozen bolts, nuts or similar objects (“work pieces”). Excessive force may also be applied when over tightening a work piece.

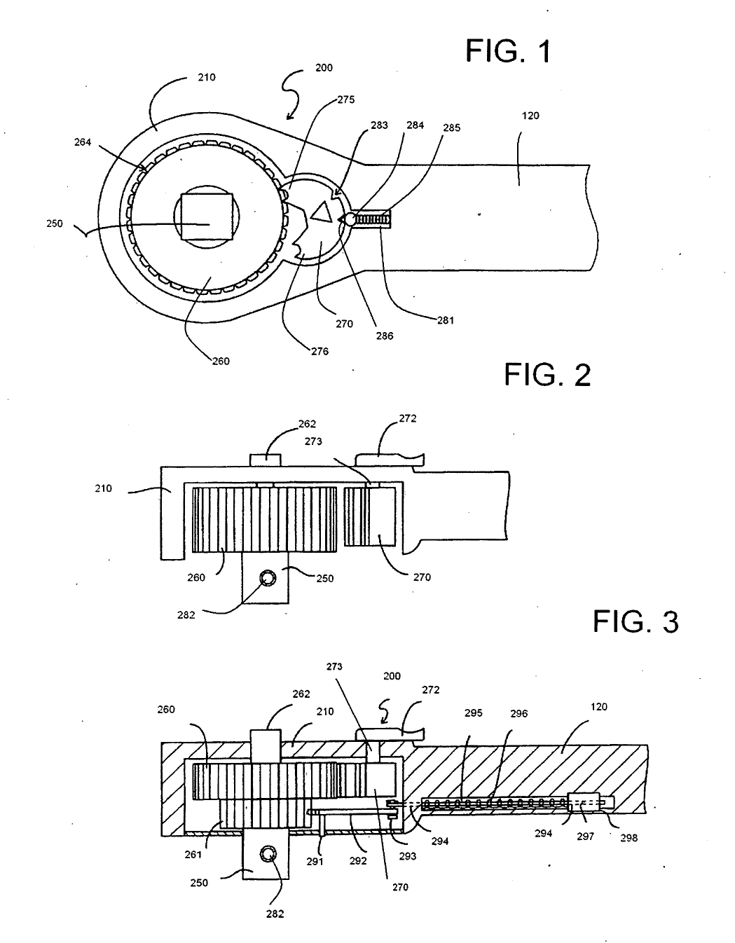

The components of ratchet tools can be understood by review. An example of a known ratchet tool is illustrated in FIGS. 1 and 2, being top and side views of a common reversible ratchet tool 200. Illustrated is the tool handle 120, ratchet head 210 and socket pin 250. The reversible ratchet device comprises a two position pawl 270 comprising two sets of teeth 275, 276 which alternately engage the teeth 264 of a ratchet wheel 260 (also known as a spur gear) for rotating, via a gear shaft 262, the socket pin in either a clockwise or counter clockwise direction. The motion of the socket pin in the ratchet component is controlled by the operation of a pawl engaging a ratchet wheel. The pawl permits the ratchet wheel to move in one direction only in response to rotation of the handle. The ratchet wheel and socket pin can freely rotate in the opposite (reverse) direction. For the ratchet component, torque force applied to the handle is transferred through the pawl and ratchet wheel to the socket pin via the interlocking pawl teeth and ratchet wheel teeth.

Referring to FIG. 2, the pawl assembly includes a pawl lever 272 connected via a shaft 273 to the pawl 270 for switching as desired by the user, between engagement, for clockwise or counterclockwise rotation of the ratchet wheel and socket pin. Other components illustrated in FIGS. 1 and 2 are: the gear shaft 262 connected to the ratchet wheel and socket pin, and a detent mechanism 281 for the pawl in conjunction with the handle. The detent mechanism comprises a ball 284 fitting into a notch 286 in the pawl. The ball is pressed into the notch by the action of a spring 285. A second notch 283 is shown and used for engaging the pawl with the ratchet wheel for turning the socket pin in the opposite direction via the handle.

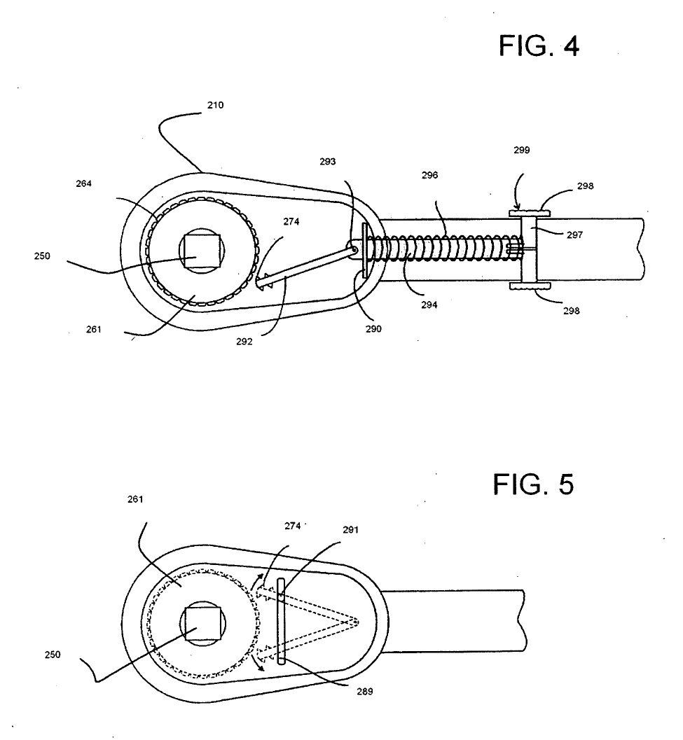

One of the many improvements that have been claimed to the basic reversible ratchet described above is disclosed in U.S. Pat. No. 5,761,972 issued to J. A. Sanders. The improvement functions to allow the user to finger tighten a work piece by manipulation of components or controls accessible on the tool handle. Briefly, and with reference to FIGS. 3, 4 and 5, the reversible ratchet tool 200 comprises a handle 120, a ratchet head 210, socket pin 250, ratchet wheel 260 with ratchet teeth 264, two position pawl 270, pawl lever 272 and pawl lever shaft 273. In addition, the device comprises a step down ratchet wheel 261 having ratchet teeth engaged by a second set of pawl teeth 274 (FIG. 4) at a free end of an advancing rod 292 that is pivotally connected via a pivotal pin 293 to a link rod 294. The link rod is held in an aperture or slot 295 within the tool handle. The link rod is held in place at one end via a retaining bar 290 holding a separate spring 296 and engaged to a slide 297 at the opposite end. The slide is controlled by finger pads 298 of the advancing lever 299. The advancing levers are accessible to the user through the tool handle. FIG. 5 illustrates the manner that the direction of the finger tightening pawls can be controlled by a separate flipper pin 291 accessible through a slot 289 in the ratchet head.

The numerous small components of the improvement subject of U.S. Pat. No. 5,761,972 have an articulated relationship to the socket pin and the tool handle. It will be appreciated that it is through the handle and the tool head that the user applies torque force to rotate the socket pin, and thereby the socket wrench and work piece. It will be further appreciated that additional or greater force may be applied to free a stuck or frozen work piece. In the ratchet tool, all of the force is transferred through the interlocking teeth 264, 275 of the ratchet wheel and pawl. This results in a large load being placed on the numerous and relatively small components and subjecting the components to wear and failure.

Tool failure results in lost time, loss of productivity and increased expense. It will be appreciated that warranty repair or replacement of ratchet tools by tool manufacturers is a significant expense. Tool failure can also result in injury to the user. It can also result in damage to the work piece.

One of the problems solved by the present invention is the ability to utilize substantial torque force through the tool handle without risk of damaging the internal components of a ratchet tool. One application of the present invention pertains to adapting a ratchet wrench (“ratchet tool”) to applications where additional torque force is applied to the work piece.

One of the problems experienced by mechanics and others using ratchet wrenches is the limited ability to manipulate the hand tool when operating in a confined area. Often times the ratchet tool is being used in a constricted or confined work areas with limited movement available to the tool. In fact, these applications are generally where ratchet tools can be most effective.

It is not uncommon that the work piece may be within the reach of the user but hidden from view by other objects. Placement of the socket wrench on the work piece may be accomplished only by “touch”. Working in this environment makes changing tools difficult and time consuming. Presently, changing tools is required if the work piece does not become free with reasonable force.

In other applications, the confined work area may prevent the use of tools having long handles that permit greater torque force to be applied by the user. Typically, tools adapted for use with socket wrenches in applications wherein significant force is required have the socket pin integral to the handle or utilize a socket pin pivotally mounted to the tool handle. These tools do not utilize or incorporate a ratchet mechanism. Torque force is applied directly to the socket pin from the tool handle. These tools are referred to in this disclosure as “breakover” tools. The necessity of having separate tools for different applications increases expense, storage and inventorying.

The present invention advantageously combines the convenience of a conventional reversible ratchet tool with a breakover tool. The tool comprises a handle (tool handle) with a ratchet tool component at a first handle end and a breakover tool component incorporated into the second end of the tool handle.

In one embodiment, the tool is configured with a tool handle of the conventional length of a hand held ratchet tool, i.e., within a range of approximately 5 to 21 inches. This permits the tool to be utilized in the confined spaces accessible with a conventional reversible ratchet tool. In applications wherein the user is attempting to remove a work piece, i.e., loosen and unthread a bolt, nut, etc., the user may immediately switch from the ratchet tool end to the breakover tool end of the tool handle in the event the work piece does not loosen. Once loose, the user may switch to the ratchet tool end. The tool permits the user to apply greater (higher) torque force to the socket wrench without risk of damage or failure of the ratcheting mechanism, e.g., the pawl or ratchet wheel teeth. The tool combination of the subject invention may also be termed a high torque force socket wrench application tool. The process of switching tool ends is enhanced when the tool incorporates a button controlled detent subcomponent for the release and holding of the socket wrench.

Ratchet tools adapted with the breakover tool component can be supplied with longer handles, i.e., greater than 21 inches. The additional torque force created at the tool head by a long handled tool can be safely utilized with the breakover tool component.

The socket pin diameter can be in a range of ¼ inch to greater than 3 inches. It can also be in a range of 5 mm to 75 mm or greater. It will be appreciated that the diameter of the socket pin will match the aperture of one side of the socket wrench.

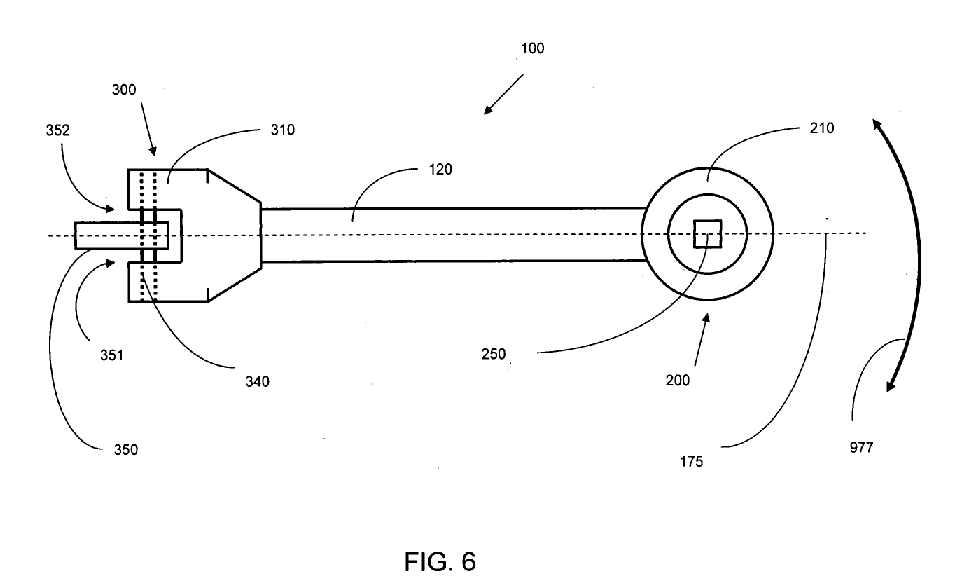

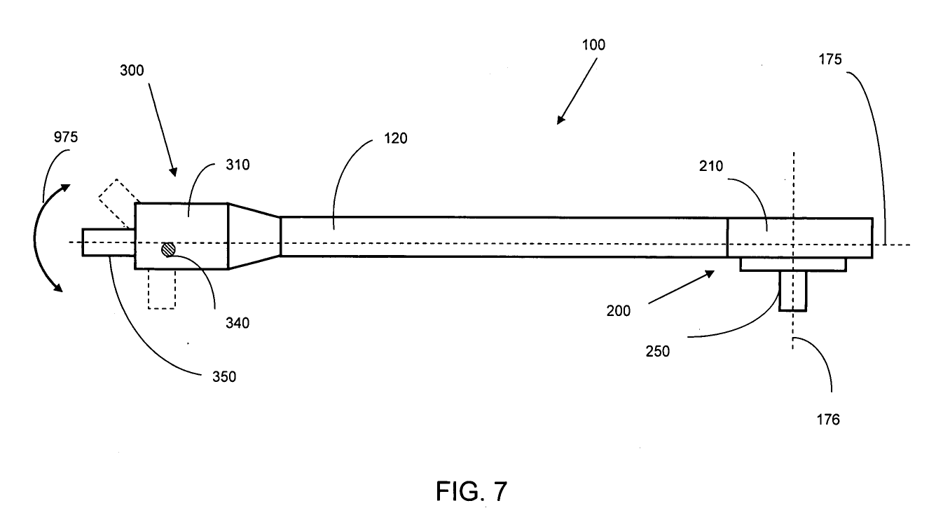

With reference to FIGS. 6 and 7, the ratchet breakover tool 100 comprises a tool handle 120, a ratchet tool 200 and a breakover tool 300. The tool handle is a stiff or rigid elongated bar or rod shaped component having a first end and a second end. The tool handle, ratchet tool or breakover tool may be made of steel. The first end comprises a ratchet tool 200 and the second end comprises a breakover tool 300. The tool handle has a longitudinal orientation 175.

The ratchet tool comprises a ratchet head 210. Within the ratchet head are the socket pin 250 (which may be referenced as a “ratcheting socket pin”) and ratchet components (not shown) such as a ratchet wheel and pawl. The ratchet tool components of various configurations are known in the technology. The mechanisms of conventional reversible ratchet devices have been described in detail above. It will be readily appreciated that the operation of the pawl of the ratchet tool allows free rotation of the socket pin in one direction while causing the socket pin to move in a fixed rotation with the tool handle in the opposing direction.

The socket pin of the ratchet tool illustrated in FIGS. 6 and 7 is set in 90 degrees orientation 176 (orthogonal) to the tool handle longitudinal orientation 175.

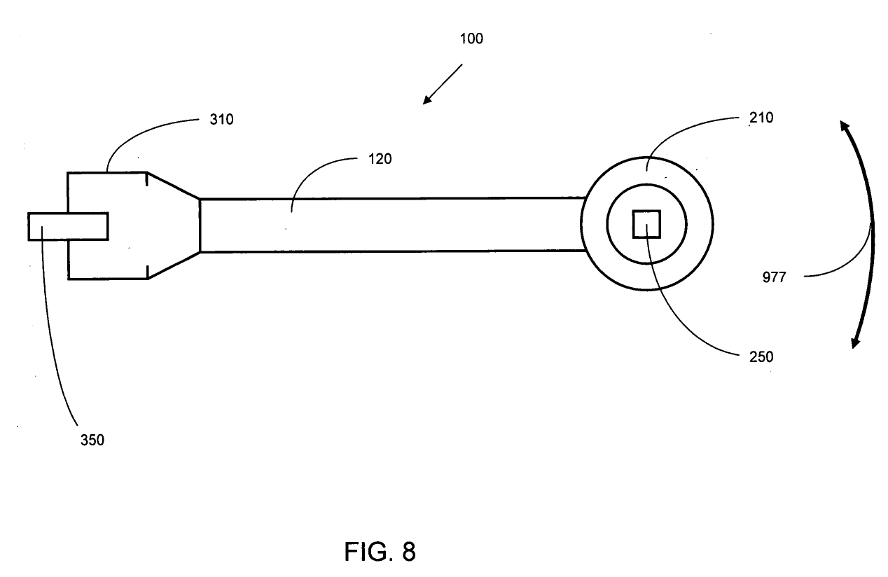

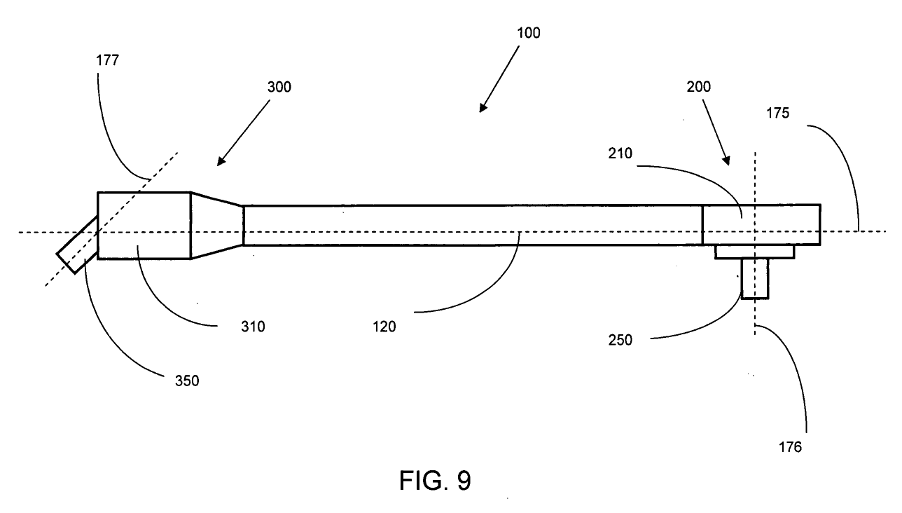

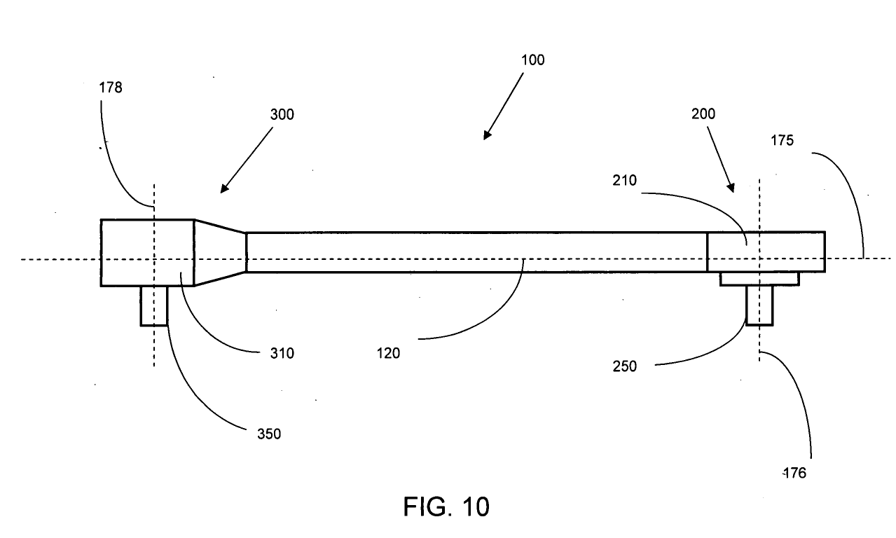

The breakover tool comprises a tool head 310 and socket pin 350. In the embodiment illustrated, the tool head is enlarged to allow increased torque force to be applied. The socket pin (“breakover socket pin” or “fixed socket pin”) of the breakover component may pivot upon an axle 340 in relation to the tool handle longitudinal orientation. The direction of this pivot movement is illustrated by the vector arrow 975. It will be appreciated that the gap 351, 352 illustrated between the tool head and the socket pin is exaggerated for purpose of illustration. The tool head may abut the side of the socket pin to provide lateral support. FIG. 7 illustrates the variable positions of the pivoting socket pin 350, and the pivot motion in the directions illustrated by vector arrow 975. The socket pin is fixed to the tool head, i.e., it will rotate with rotation of the handle in the direction of the vector arrow 977 illustrated in FIGS. 6 and 8. Unlike the ratchet tool head, there is no direction of free rotation (clockwise or counter clockwise). The socket pin may also be set in and integral to the tool head, i.e., the socket pin does not pivot on an axle. See, for example, FIGS. 8 and 9 wherein the breakover socket pin 350 is set in an oblique angle 177, 175 to the tool handle 120. FIG. 10 illustrates another embodiment wherein the socket pin is set in a 90 degree angle 178, 175 to the tool handle longitudinal orientation.

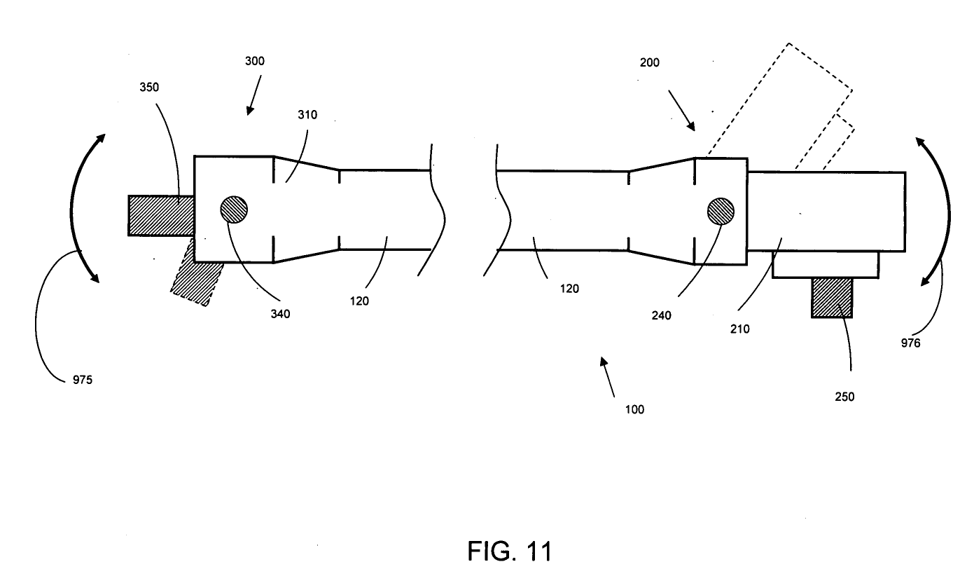

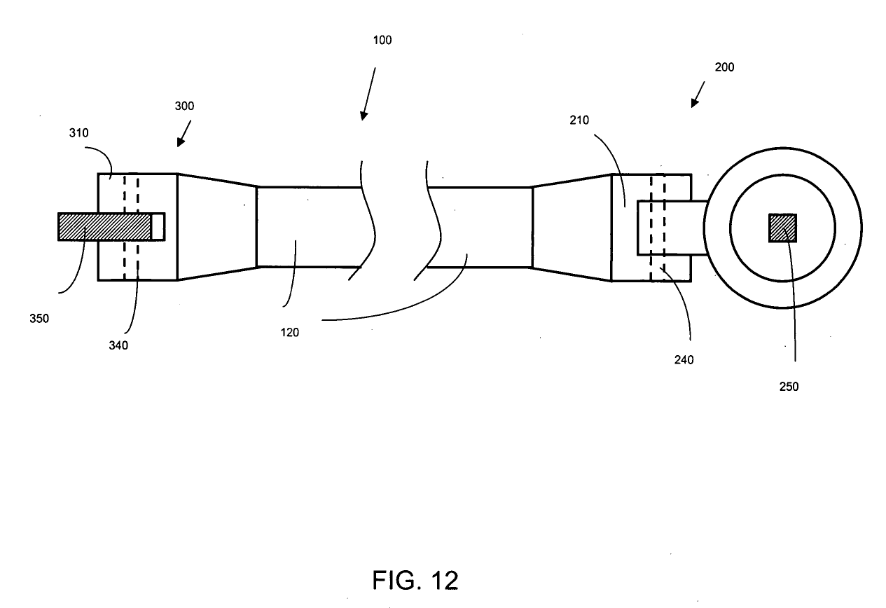

Another embodiment of the invention is illustrated in FIGS. 11 and 12. In this embodiment of the invention, the socket pin 350 of the breakover tool 300 pivots on the axle 340 within the tool head 310. The direction of movement is shown by the vector arrow 975. The ratchet tool 200 also pivots at the end of the tool handle 120 on an axle 240 connecting the tool head 210 to the handle. The direction of this movement is illustrated by the vector arrow 976. Alternate positions of the breakover tool socket pin and the ratchet tool head are also shown in dashed lines. It will be appreciated by persons skilled in the technology that this adaptation increases the flexibility of tool, particularly when used in constricted or confined work spaces.

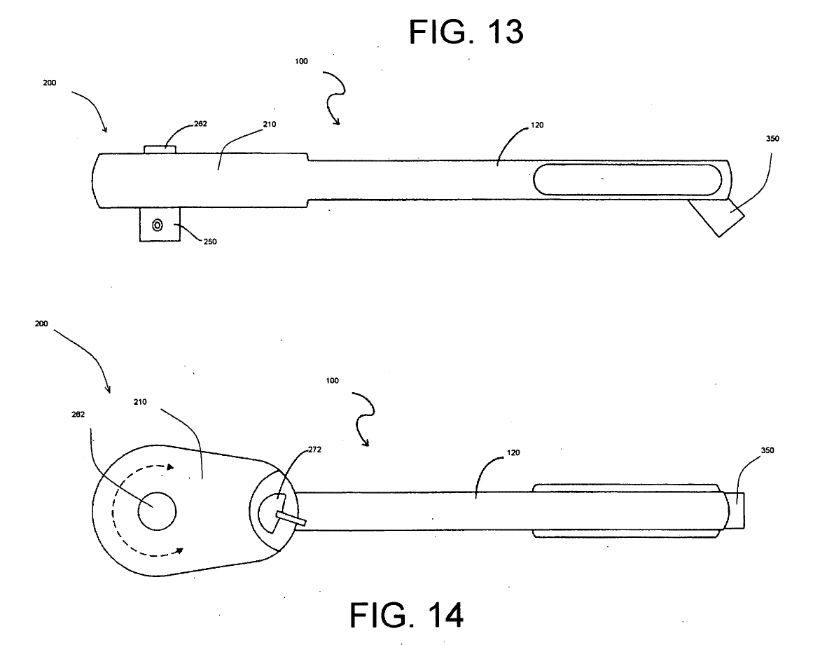

In an additional embodiment illustrated by FIGS. 13 and 14, the tool 100 subject of the invention comprises a reversible ratchet tool 200 comprised of a ratchet tool head 210, socket pin 250 and a handle 120 wherein a separate fixed socket pin 350 is set in the handle end. The socket pin 350 is integral to the handle. Also illustrated are the pawl control lever 272 and the gear shaft 262. By movement of the pawl control lever, the rotation of the socket pin 250 can be controlled to one of either the clockwise or counter clockwise direction (illustrated by the vector arrow). Increased torque force can be applied to a work piece utilizing the fixed socket pin 350 with the socket wrench (not shown) without risk of damage to the pawl and ratchet wheel components (not shown) of the ratchet tool 200. It will be appreciated that the handle end socket pin 350 performs the same task of the breakover tool. In the embodiment illustrated in FIGS. 13 and 14, this socket pin 350 is set at an oblique angle to the handle longitudinal orientation. It will be further appreciated that this fixed socket pin can be set in other orientations, including at an orthogonal angle to the handle longitudinal orientation. It will be further appreciated that the handle end can form the socket pin, i.e., the handle end being shaped and dimensioned to form a socket pin.

The socket pin 250, 350 is a male component having at least three corners and that can be inserted into a compatible female aperture of the socket wrench (not shown). The socket pins illustrated in the figures incorporated within this disclosure each have four corners as is conventional. When inserted into the aperture of the socket wrench, i.e., having a matching diameter and number of corners, rotation of the socket pin causes rotation of the socket wrench. The socket pin can be rotated about an axis. This rotation is controlled by movement of the tool handle.

One or both of the socket pins of the tool subject of this invention may include a conventional detent and control component, such as a spring loaded ball with a control button, which can be useful for holding and releasing the socket wrench from the tool. This ball detent subcomponent is conventional for a ratchet tool. Such a subcomponent is illustrated in FIGS. 2 and 3. The socket pin 250 includes a spring operated ball component 282 which protrudes from the side of the socket pin. The spring is controlled by the user pressing a button (not shown) located with the gear shaft 262 on the tool head. When the button is pressed, the spring tension is released upon the ball, thereby allowing the detent ball to move fully into the socket pin and releasing the socket wrench. The present invention may be advantageously configured with a ball detent subcomponent for both the breakover tool and the ratchet tool.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

1. (canceled)

2. (canceled)

3. (canceled)

4. (canceled)

5. A tool comprising a handle having a first end and a second end and further comprising a ratchet tool at the first handle end and a breakover tool at the second handle end further comprising a socket pin of the breakover tool set in an orthogonal angle to the handle.

6. The tool of claim 5 wherein the socket pin is set in an oblique angle to the handle.

7. A tool comprising a handle having a first end and a second end and further comprising a ratchet tool at the first handle end and a breakover tool at the second handle end wherein a socket pin of the ratchet tool is the same diameter as a socket pin of the breakover tool.

8. The tool of claim 1 wherein the diameter of a socket pin is in a range of 1 inch to 3 inches.

9. A tool comprising a handle having a first end and a second end and further comprising a ratchet tool at the first handle end and a breakover tool at the second handle end wherein the diameter of a socket pin is in a range of 5 mm to 75 mm.

10. A tool comprising a handle having a first end and a second end and further comprising a ratchet tool at the first handle end and a breakover tool at the second handle end wherein the length of the handle is in a range of 9 inches to 21 inches.

11. (canceled)

12. A tool comprising a handle having a first end and a second end and further comprising a ratchet tool at the first handle end and a breakover tool at the second handle end wherein at least one of the tool ends comprises a detent.

13. A tool comprising a handle having a first end and a second end and further comprising a ratchet tool at the first handle end and a breakover tool at the second handle end wherein the ratchet tool pivots on an axle and a socket pin of the breakover tool pivots on an axle.

14. A tool comprising a handle having a first end and a second end and further comprising a ratchet tool at the first handle end and a breakover tool at the second handle end wherein the ratchet tool pivots on an axle.

15. A high torque force socket wrench application, tool comprising:
a. a tool handle approximately 9 inches to 21 inches in length having a first end and a second end;
b. a reversible ratchet tool attached to the first handle end and comprising a socket pin with a diameter of ¼ inch to ¾ inch and a socket wrench detent; end
c. a breakover tool attached to the second handle end and comprising a socket pin pivotally attached to a breakover tool head and with a diameter of ¼ inch to ¾ inch and a socket wrench detent.

16. The tool of claim 15 wherein the ratchet tool is pivotally attached to the tool handle.

17. A high torque force socket wrench application tool comprising;
a. a tool handle approximately 5 inches to 21 inches in length having a first end and a second end;
b. a reversible ratchet tool attached to the first handle end and comprising a socket pin with a diameter of ¼ inch to ¾ inch and a socket wrench detent; and
c. a breakover tool attached at an oblique angle to the second handle end and comprising a socket pin set in a breakover tool head and with a diameter of ¼ inch to ¾ inch and a socket wrench detent.

18. A tool handle comprising a first and second end and further comprising a ratchet tool at the first end and a socket pin at the second end.

19. The tool handle of claim 18 wherein the handle length is in a range of 9 inches to 21 inches and the ratchet tool comprises a socket pin of the same diameter as the socket pin at the second handle end and in a range of ¼ inch to ¾ inch and the ratchet tool further comprising a detent.

20. The tool handle of claim 19 wherein the ratchet tool is pivotally attached.

21. A method of removing a work piece utilizing a socket wrench in combination with a tool having a handle with a ratcheting socket pin at a first handle end and a fixed socket pin at a second handle end and comprising first loosening the work piece by installing a socket wrench on the fixed socket pin, placing the socket wrench on the work piece, applying sufficient force to loosen the work piece, and then placing a socket wrench on the ratcheting socket pin to complete removal.
